(19) United States
(12) Patent Application Publication
(10) Pub. No.: US 2007/0193701 A1
(43) Pub. Date: Aug. 23, 2007

(54) Rolling hurricane and security shutter

(76) Inventors: Frank Petrick, Fort Myers, FL (US); Matthias Krebs, Pillgram (DE); Tobias Petrick, Frankfurt (DE)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/642,246

(22) Filed: Dec. 20, 2006

Related U.S. Application Data
(60) Provisional application No. 60/752,725, filed on Dec. 21, 2005.

(51) Int. Cl. E06B 9/08

(52) U.S. Cl. 160/133

(57) ABSTRACT

A rolling shutter assembly including a plurality of interconnecting slats each having an elongated body with a top, bottom, and two sides. Connectors are affixed to the top and bottom of each slat, and a retainer member is attached to each side of each slat. The slats are connected to each other by the hooking together the connectors of the slats. The slats are placed within two tracks located on either side of an opening, and are movable between an open and closed position in between the two tracks. The tracks have retention ledges, contact material holders, and two chambers. In operation, the retention members attached to the slats come into contact with the retention ledges of the tracks when a force is applied to the shutter assembly, thereby preventing the slats from becoming dislodged from the tracks.

### CROSS-REFERENCE TO RELATED APPLICATION

This application claims priority to the co-pending U.S. Provisional Application No. 60/752,725, filed Dec. 21, 2005, the entire contents of which are incorporated herein by reference.

### BACKGROUND OF THE INVENTION

1. Field of the Invention

The present invention relates to hurricane and security shutters. More particularly, this invention relates to a plurality of interconnected shutter slats that are movable in between two tracks mounted on either side of an opening, wherein the shutter protects the opening from hurricane winds, projectiles, and other outside forces.

2. General Background and State of the Art

Rolling protective shutters for covering windows, doors and other portal openings of a building structure such as homes and office buildings are well known in the art. In many cases, protective shutters are primarily used for the purpose of protecting windows and doors from high velocity winds and flying debris during tropical storms and hurricanes. In other cases, protective shutters are used to provide security against forced entry. Such prior art shutter systems are commercially available in many different types, and may be manufactured out of light metal or plastic. Prior art rolling shutters typically include a plane of horizontal slats which are linked so that the shutter can be rolled-up onto a roller for storage. The prior art storage roller is usually contained within a housing that may be mounted above a window or door opening in a building. In the use of the prior art rolling shutters, the storage roller is typically rotated in opposite directions by a small electric motor in order to roll the shutter onto the roller for storage, and unroll the shutter downward into a plane in order to provide protection for the opening. As the prior art shutter is unrolled, the opposite ends of the plurality of slats are received and guided in rails that are secured to an exterior structure at opposite sides of the opening. The prior art guide rails are usually linear and retain the unrolled shutter slats in a generally coplanar relation parallel to the plane of the opening.

Several prior art rolling shutter assemblies include elongated aluminum shutter slats that are hinged together along their top and bottom edges and that are placed in between two tracks. The slats are movable between the two tracks such that the slats may move between a rolled and unrolled position, wherein the slats in the unrolled position provides protection to an opening. As with any such support and guide system for the prior art slats, it has been found desirable to provide a high strength connection between each slat and the tracks. It has also been found desirable to provide for the smooth and low friction movement of the slats so that the slats may be moved in between the tracks without binding. Further, it is desirable for the shutter to avoid damage to the shutter slats and tracks, because if the slats or tracks are damaged, the plane of shutter slats will not be able to roll up upon the roller assembly or unroll into the tracks efficiently.

Where the prior art shutter slats are rolled-down and the shutter is subjected to hurricane force winds or other forces, the plane of shutter slats bends inward or outward so much that the plane of shutter slats is able to be ripped out of its location between the tracks. In order to prevent this bending, prior art shutter slats have been reinforced with vertical bars so that the slats resist bending when they are subjected to hurricane force winds, but such vertical bars provided little added support and are difficult and inconvenient to use. Prior art shutter slats have also been reinforced with rods placed inside of hollow shutter slats to prevent the slats from bending, but such rods added significant weight to the rolling shutter. In addition, certain prior art slats are retained within the tracks with the use of screws which attach to the opposite ends of the slats and extend outwardly from the slats. The prior art screw heads are often sheared off when subjected to a sufficient force of impact. Accordingly, there remains a need in the art for an improved method for securing the ends of the shutter slats within the tracks so that the shutter slats do not disengage from the tracks or damage themselves or the tracks when being subjected to high velocity winds, forces of impact and projectiles.

### SUMMARY OF THE INVENTION

An aspect of the invention provides a shutter assembly for covering an opening made of a plurality of interconnected slats and two tracks. Each slat has connectors on its top and bottom, retention members on its ends and a cavity which may be filled with a cavity insert for extra security. A plurality of slats is interconnected by engaging the connectors located at the top and bottom of each slat. The two tracks are placed opposite the opening, such as a window or a door, and receive the plurality of slats to protect the opening. The plurality of slats may be rolled up and dropped down between the two tracks. Each track substantially forms a channel having two chambers, and each has a retention ledge and contact material holders. During operation, when the opening is covered by the shutter assembly and a force is pressing against the shutter assembly, the retention members contact the retention ledges of the tracks and prohibit the slats from exiting the tracks. Further, the slats are forced against a contact material that is located within the contact material holders to help retain the slats within the tracks.

### BRIEF DESCRIPTION OF THE DRAWINGS

FIG. 1 is a front perspective view of the rolling shutter assembly of the present invention covering an opening;

FIG. 2 is a cross-sectional view of a track of the shutter assembly;

FIG. 3 is a perspective view of a break-away portion of the contact material;

FIG. 4 is a perspective view of four interconnected slats with retention members;

FIG. 5 is an end view of five slats interconnected with the bottom slat;

FIG. 6 is an end view of a single slat;

FIG. 7 is a perspective view of a retention member;

FIG. 8 is an end view of a cavity insert;

FIG. 9 is a side view of a rolling shutter assembly wherein the roll of interconnected slats is housed on the exterior of the structure that forms the opening;

FIG. 10 is a side view of a rolling shutter assembly wherein the roll of interconnected slats is housed on the interior of the structure that forms the opening;

FIG. 11 is a perspective view of a plurality of interconnected slats placed within a track;

FIG. 12 is a roll of the plurality of interconnected slats;

FIG. 13 is a partial cross-sectional view of the slat placed within the tracks, wherein the slat is bending inward toward the opening; and

FIG. 14 is a partial cross-sectional view of the slat placed within the tracks, wherein the slat is bending outward away from the opening.

### DETAILED DESCRIPTION OF THE PREFERRED EMBODIMENTS

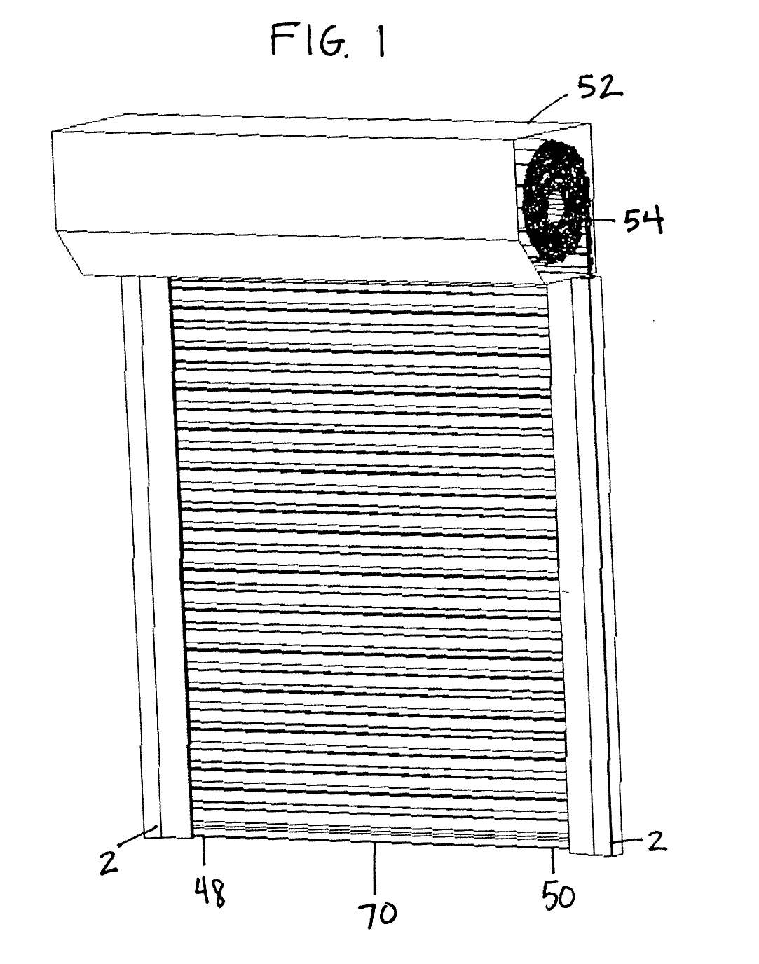

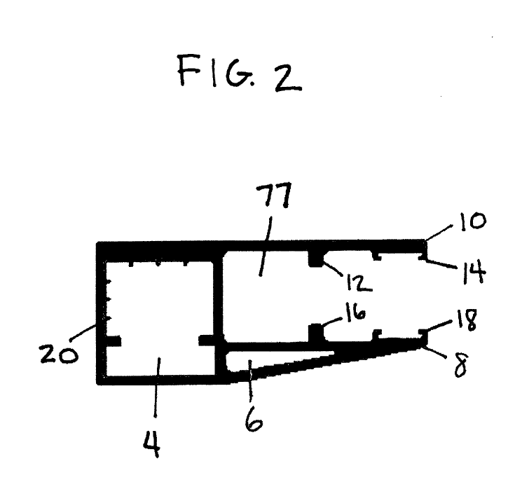

Embodiments of the shutter assembly for protecting an opening, such as a glass window or a door of a structure are described herein. Referring now to FIG. 1, a security shutter is shown installed inside or outside a structure for covering an opening such as a window or door. A pair of main tracks 2 is made of aluminum, stainless steel or a material that is similarly durable and corrosion-resistant. The main tracks 2 generally run the length of the opening on either side of the opening, and are fastened to the structure forming the opening with screws, nails, or the other fastener. Referring now to FIG. 2, the main track defines a first chamber 4, and a second chamber 6. The second chamber 6 is generally located on the outside of a second main track wall 8, and in one embodiment, defines a volumetric shape composed of two substantially triangular bases and three substantially rectangular sides in order to provide support and additional strength to second main track wall 8, particularly when a force is applied upon the second main track wall 8. In other words, the second chamber has a triangular cross-sectional shape. It has also been contemplated that the second chamber may have a rectangular, oval or other geometric cross-sectional shape. Further, it is noted that additional closed chambers beyond the first chamber and second chamber may be added to the main track. The first chamber 4 and second chamber 6 are designed to conserve materials and to reduce the weight of the main tracks. However in other embodiments, either the first chamber 4 or second chamber 6 may be omitted.

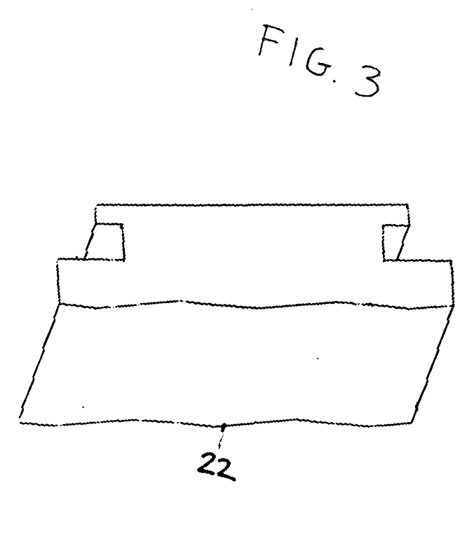

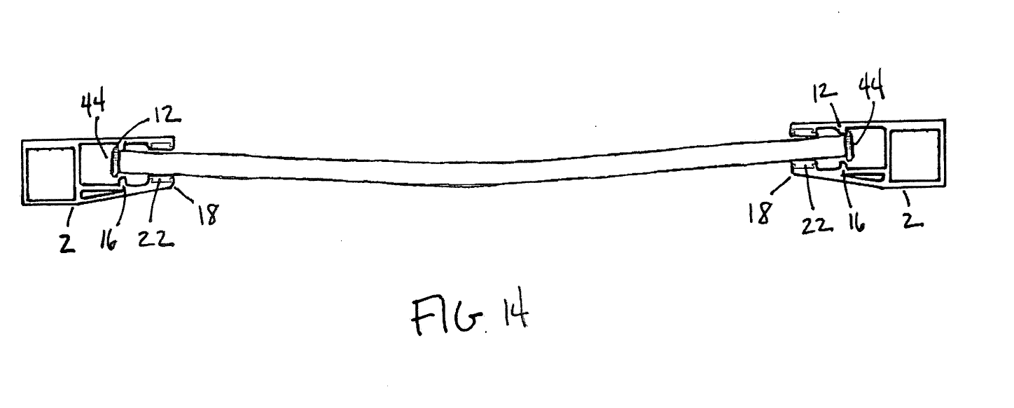

Still referring to FIG. 2, a first main track wall 10 has a first retention ledge or first ledge 12, and a contact material holder 14. Likewise, a second main track wall 8 has a second retention ledge or second ledge 16 and a contact material holder 18. The first ledge 12 and the second ledge 16, as well as the contact material holders 14 and 18 are generally constructed from the same material as the main track, and in one embodiment, are formed together as a part of the main track. The first main track wall 10 and the second main track wall 8 are generally perpendicular to and affixed to a base wall 20. The first ledge 12 and second ledge 16, as well as the contact material holders 14 and 18 substantially run the entire length of the main track 2, and run substantially parallel to the main track wall upon which they are affixed. A perspective cut-away view of a contact material 22 is shown in FIG. 3. In one embodiment, the contact material 22 is substantially inserted into the contact material holders 14 and 18 as shown in FIG. 14. The contract material is generally made of hard rubber or of a substance that is similarly durable, shock-absorbing, and relatively light weight. Also, the contact material 22 is approximately the same length as the contact holder to which it is affixed. Thus, the contact material 22 is inserted into the contact material holders such that the contact material 22 substantially runs the length of the contact material holder to which it is affixed.

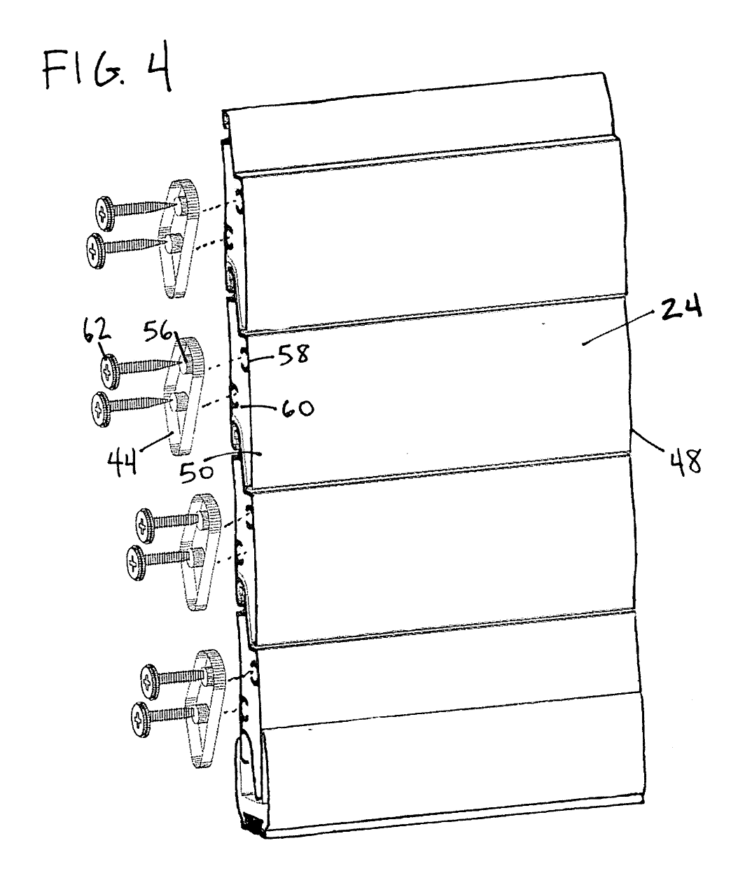

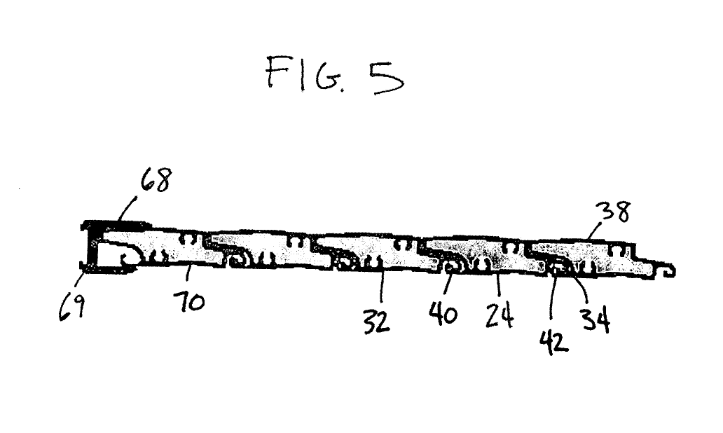

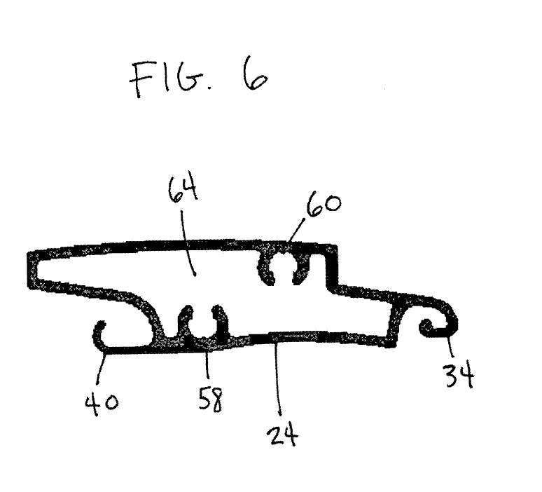

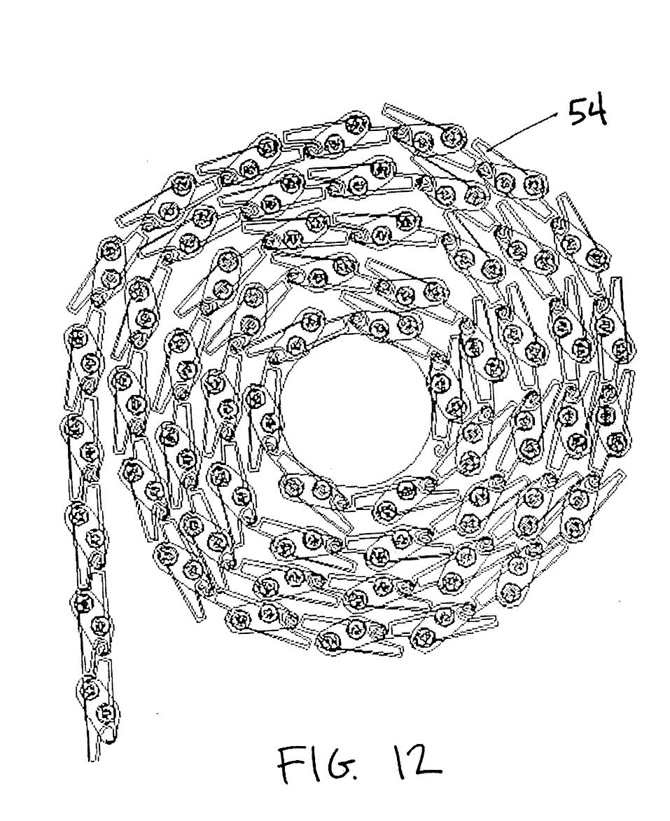

FIGS. 4 and 5 depict slats 24 that are interconnected with one another. In one embodiment, the slats are made of aluminum; however, in other embodiments the slats may be made of stainless steel or another material that is similarly durable and corrosion-resistant. The interconnected slat 24 is substantially shaped such that it rests flush against, and overlaps at least a portion of slat 32. As best shown in FIG. 5, an adjacent slat 24 has a first hook ledge or first connector 34 disposed on its top surface or side, and a second hook ledge or second connector 40 disposed on its bottom surface or side. In one embodiment, the first and second connectors 34 and 40 substantially run the entire length of the slat. As shown in FIG. 6, the first connector 34 curves inward toward the center of the first connector, and the second connector 40 curves inward toward the center of the second connector having a general shape of a traditional hook. The shape of the first connector 34 of slat 24 and the second connector 42 of neighboring slat 38, when hooked together as shown in FIG. 5, have the utility of allowing the interconnected slats to achieve a tighter roll 54 (see FIG. 12) when rolled-up within the roller assembly.

Referring back to FIG. 4, an end retention portion or a retention member 44 is constructed of aluminum; however, the retention member 44 may be made of stainless steel or another material that is similarly durable and corrosion-resistant. In one embodiment, the retention member 44 is substantially shaped as a half-oval, half-trapezoid. The shape allows the retention members to be affixed to both a first end 48 and a second end 50 of each interconnected slat, as the retention members will not significantly come into contact with each other when rolled-up within the roller assembly. Affixing two retention members to each slat strengthens the shutter assembly. Generally, there is an end retention portion on both the first end 48 and the second end 50 of each slat. This allows the plurality of interconnected slats to be rolled-up within the roller assembly and formed into the roll 54 within a housing assembly 52, as depicted in FIG. 1, such that the retention members do not come into contact with one another and prohibit the plurality of interconnected slats from rolling upon the roller assembly.

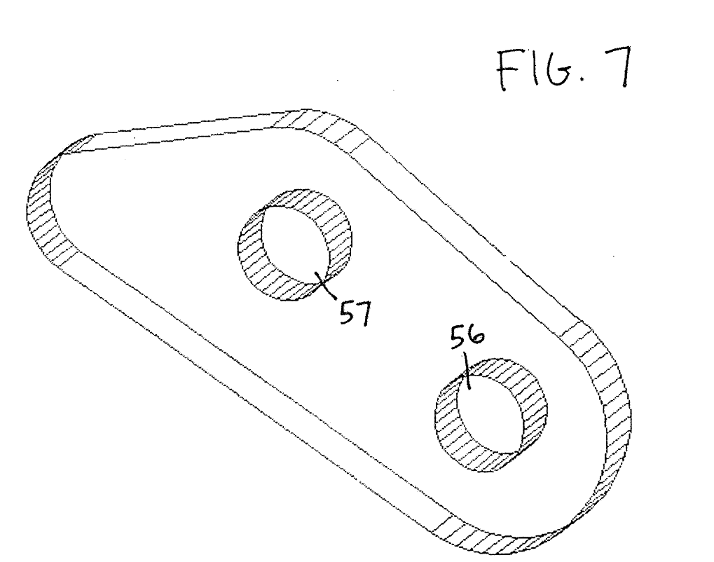

In one embodiment, the retention member 44 in FIG. 7 defines a first hole 56 and a second hole 57. In addition, the slat 24, as shown in FIG. 6, defines a first cavity 58 and a second cavity 60 which are located at both the first end 48 and the second end 50 of slat 24. The first cavity 58 and the second cavity 60 are substantially circular in shape and are flush with the end of the slat to which they are affixed. Both the first cavity 58 and second cavity 60 are blind holes and are substantially parallel to the slat to which they are affixed. A fastener, such as a self-drilling metallic screw 62 may be placed through one of the plurality of holes 56 of the retention member 44 and drilled substantially into the first cavity 58. Similarly, a second self-drilling metallic screw 62 may be placed through one of the plurality of holes 57 of the retention member 44 and drilled substantially into the second cavity 60 to affix the retention member 44 to one end 48 of the slat 24. In one embodiment, a retention member is affixed to the first end and the second end of each slat of a plurality of interconnected slats. Also, retention members may be affixed to fewer than each end of every slat.

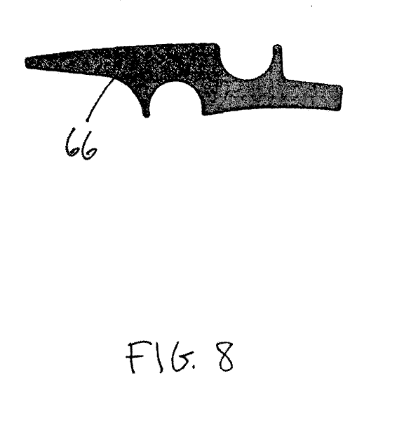

In one embodiment, an interconnected slat 24 has a slat cavity 64 as shown in FIG. 6. A slat cavity insert 66 (see FIG. 8) may be placed within the slat cavity 64 in order to increase the overall strength and durability of the interconnected slat 24. The slat cavity insert 66 is inserted into the slat cavity 64 and substantially runs the length of the interconnected slat 24. Further, the slat cavity insert has a shape such that it substantially fills the slat cavity 24. In addition, the slat cavity insert 66 has a shape that accommodates the slat cavity 64 and surrounds the first slat cavity 58 and the second slat cavity 60. Also, once inserted, the slat cavity insert 66 will be substantially held in the slat cavity 64 by the retention members attached to the relevant slat. The slat cavity insert 66 may be constructed out of any material, such as aluminum, stainless steel, hard plastic, or other suitable material. In one embodiment, one slat cavity insert 66 is inserted into each interconnected slat in order to make the plurality of interconnected slats stronger and more resistant to the impact of projectiles, such as bullets or debris that is hurled at the plurality of interconnected slats by hurricane force winds.

Located above the pair of main tracks is a roller assembly 52 that houses the plurality of interconnected slats. The plurality of interconnected slats may be rolled-up, as shown in FIG. 12, upon the roller assembly into roll 54, or rolled-down into the main tracks 2 by rotating the roller assembly with the use of a motor. The slats may also be manually rolled down. The roller assembly 52 is made of aluminum, stainless steel, or another suitable material, and substantially encloses the roll 54, and protects the roll 54 from elements and exterior physical forces. As shown in FIG. 5, located at the bottom of the plurality of interconnected slats is a bottom slat 68. The bottom slat is substantially channel-shaped, and is joined to the second to last slat 70 of a plurality of interconnected slats. More specifically, the bottom slat is affixed to slat 70 of the plurality of interconnected slats such that the bottom slat 68 substantially encloses the second connector and at least a portion of slat 70. In addition, the bottom slat 68 runs substantially the length of the interconnected slats. The bottom slat 68 provides additional strength and support to the interconnected slats. A contact material holder 69 is formed on the bottom of the bottom slat and runs the length of the bottom slat, inside of which may be placed contact material 22 for additional strength.

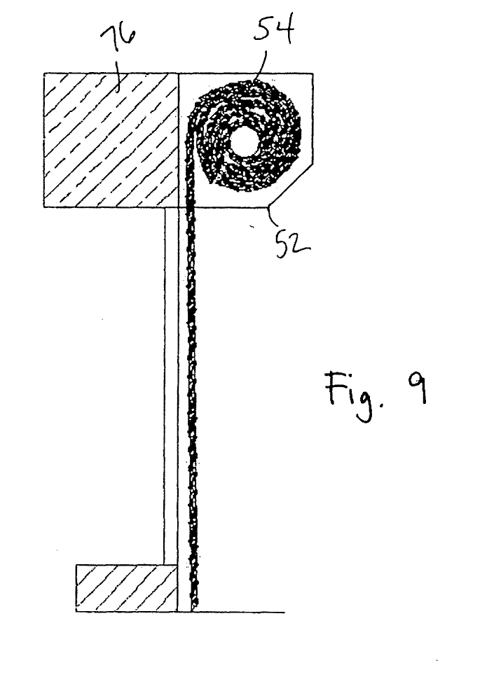

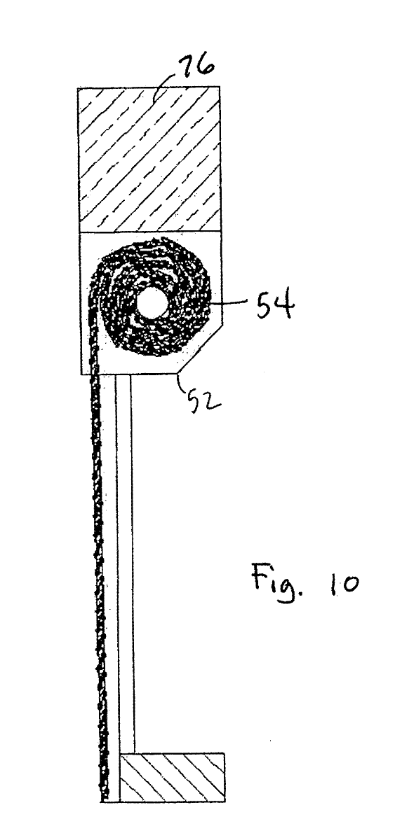

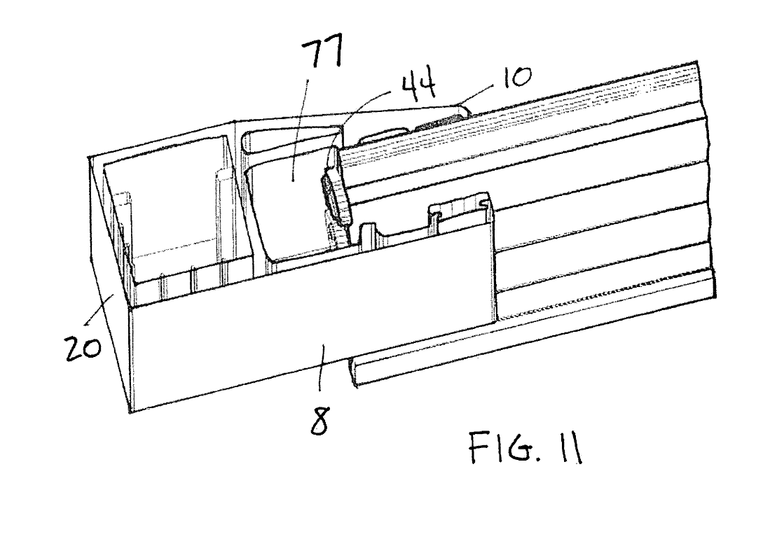

In operation, the interconnected slats are rolled down into the pair of main tracks 2 by the roller assembly such that the interconnected slats fall in between the first main track wall 10 and the second main track wall 8. In one embodiment, as shown in FIG. 9, the interconnected slats may be rolled down from assembly 52 into the pair of main tracks 2. In this embodiment, the assembly 52 is located on the outside of the structure of an opening 76. In another embodiment, as shown in FIG. 10, the assembly 52 is located within the structure 77 forming the opening 76. The interconnected slats are rolled down into the pair of main tracks such that a retention member 44 attached to the ends of the slats 24 fall into a main track cavity 77 defined by the base wall 20, the first main track wall 10, the first ledge 12, the second main track wall 8, and the second ledge 16, as shown in FIGS. 2 and 11. With the interconnected slats in the rolled-down position, the slat 24, is positioned substantially flush against, and overlaps, a neighboring slat 32 as shown in FIG. 5.

The slats overlap each other such that, when a force is applied against the slats, each slat pushes against a neighboring slat, causing the slats to interlock and form a plane of slats. Thus, the inward force is absorbed across the plane of slats as the plane comes into contact with the contact material 22 located within the contact material holders 14 of the main tracks 2. This arrangement is particularly useful for protecting the opening from projectiles that are hurled at the slats and that strike the slats at any one point on the plane of slats. When used as shown in FIG. 9, the slats also overlap each other. However, when a force is applied against the slats, each slat does not push against a neighboring slat to cause the slats to interlock and form a plane of slats. Rather, as shown in FIGS. 9 and 12, when a projectile is hurled at the plane of slats and strikes a single point on the plane of slats, the particular slats that the projectile strikes will absorb the inward force by striking the first main walls 10 of the main tracks 2.

In one embodiment, with the plurality of interconnected slats rolled down completely into the main tracks 2 as shown in FIG. 10, a force that is applied against the plurality of interconnected slats is absorbed substantially across the entire plane of slats as the plane of slats contacts the first main walls 10 of the main tracks 2 or the contact materials 22 attached to the contact material holders 14. Similarly, the plurality of slats protects the opening from outside forces applied away from the plurality of interconnected slats, such as a suction caused by winds moving away from the opening, is absorbed by the interconnected slats as they impact the contact material 22 attached to the contact material holder 18. The plurality of slats withstands forces in either horizontal direction applied against the plane formed by the plurality of interconnected slats, as the first ledge 12 and the second ledge 16 absorb the force applied by colliding with the retention member 44 attached to one of the plurality of slats.

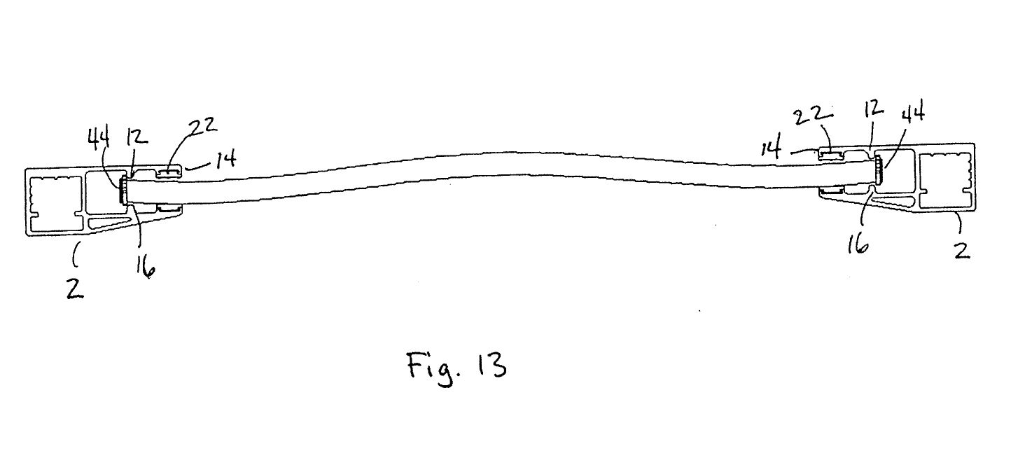

To the extent that a force applied against the plane formed by the slats causes the plane of slats to move inward toward the opening, as shown in FIG. 13, the force is absorbed as the flexed slats contact the contact material 22 that is affixed to the contact material holder 14. In addition, the inward force is absorbed as the first connector 12 and the second connector 16 collide with the retention member 44 that is affixed to each end of each of the slats. To the extent that a suction force causes the slats to move outward and away from the opening, as shown in FIG. 14, the force applied is absorbed as the flexed slats contact the contact material 22 that is affixed to the contact material holder 18. In addition, this outward force is absorbed as the first connector 12 and the second connector 16 collide with the retention member 44 that is attached to each end of each of the slats. Further, the second chamber 6, having a triangular cross-section, provides additional support for the second main track wall 8. Once the forces are removed, the plurality of interconnected slats is rolled-up into the roller assembly either manually or with a motor.

In describing the shutter assembly and its components, certain terms have been used for understanding, brevity, and clarity. They are primarily used for descriptive purposes and are intended to be used broadly and construed in the same manner. Having now described the invention and its method of use, it should be appreciated that reasonable mechanical and operational equivalents would be apparent to those skilled in the art. Those variations are considered to be within the equivalence of the claims appended to the specification.

We claim:

1. A shutter assembly for covering an opening, comprising:
a slat having an elongated body with a first end and a second end, the slat having a first connector and a second connector disposed between the first and second ends, wherein a plurality of slats are connected to one another by engaging the first connector of the slat with the second connector of an adjacent slat such that at least a portion of the elongated body of the slat overlaps at least a portion of the elongated body of the adjacent slat;
a first track disposed adjacent the opening and defining a channel adapted to receive the first end of the elongated body of the slat; and
a second track disposed on an opposite side of the opening from the first track, the second track defining a channel adapted to receive the second end of the elongated body of the slat;
wherein the plurality of engaged slats held by the first and second tracks covers at least a portion of the opening.

2. The shutter assembly of claim 1, wherein the first and second tracks include a retention ledge disposed within the channels of the first and second tracks.

3. The shutter assembly of claim 1, wherein the first and second tracks each have a contact material holder disposed within the channel, and a contact material is disposed within the contact material holders of the first and second tracks.

4. The shutter assembly of claim 1, wherein the first and second tracks each include a chamber having a triangular cross-section.

5. The shutter assembly of claim 1, wherein the elongated body of the slat further includes a first retention member attached to the first end and a second retention member attached to the second end of the elongated body, wherein the first retention member fits within the channel of the first track and the second retention member fits within the channel of the second track.

6. The shutter assembly of claim 1, wherein the elongated body of the slat defines a cavity.

7. The shutter assembly of claim 6, wherein the cavity is at least partially filled with a cavity insert.

8. The shutter assembly of claim 1, further comprising a bottom slat being substantially channel-shaped and affixed to the plurality of engaged slats.

9. A shutter assembly for covering an opening, comprising:
a slat having an elongated body with a first end and a second end, the slat having a first connector and a second connector disposed between the first and second ends, the elongated body of the slat having a first retention member attached to the first end and a second retention member attached to the second end, and wherein a plurality of slats are connected to one another by engaging the first connector of the slat with the second connector of an adjacent slat such that at least a portion of the elongated body of the slat overlaps at least a portion of the elongated body of the adjacent slat;
a first track disposed adjacent the opening defining a channel having a retention ledge disposed within the channel, the channel having an open end and a closed end and adapted to receive the first retention member of the slat such that the first retention member is positioned between the closed end of the channel and the retention ledge; and
a second track disposed on an opposite side of the opening defining a channel having a retention ledge disposed within the channel, the channel having an open end and a closed end adapted to receive the second retention member of the slat such that the second retention member is positioned between the retention ledge and the closed end of the channel;
wherein the plurality of engaged slats held by the first and second tracks covers at least a portion of the opening.

10. The shutter assembly of claim 9, wherein the first and second tracks each have a contact material holder disposed within the channel, and a contact material is disposed within the contact material holders of the first and second tracks.

11. The shutter assembly of claim 9, wherein the first and second tracks each include a chamber that has a substantially triangular cross-section.

12. The shutter assembly of claim 9, wherein the elongated body of the slat defines a cavity.

13. The shutter assembly of claim 12, wherein the cavity is at least partially filled with a cavity insert.

14. A method of covering an opening, comprising:
affixing a first track and a second track on opposite sides of the opening, wherein the first and second tracks each define a channel;
connecting a plurality of slats to one another, each slat having an elongated body with a first end and second end and having a first connector and a second connector disposed between the first and second ends, by engaging the first connector of one slat with the second connector of an adjacent slat such that at least a portion of the elongated body of the one slat overlaps at least a portion of the body of the adjacent slat; and
inserting the first ends of the plurality of slats into the channel of the first track and the second ends of the plurality of slats into the channel of the second track, wherein the plurality of slats secured in the tracks covers at least a portion of the opening.

15. The method of claim 14, further comprising inserting a contact material within contact material holders of the first and second tracks.

16. The method of claim 14, wherein affixing the first and second tracks, the first and second tracks include a triangular shaped chamber.

17. The method of claim 14, further comprising attaching a first retention member to the first end of the slat and a second retention member to the second end of the slat and inserting the first and second retention members inside the channels of the first and second tracks, whereby, upon inward or outward inflection of the plurality of slats due to a force, the retention members come into contact with retention ledges of the tracks and prohibit the first and second ends of the plurality of slats from exiting the tracks.

18. The method of claim 14, further comprising inserting a cavity insert into a cavity defined by the elongated body of the slat.

19. The method of claim 14, further comprising attaching a bottom slat to the plurality of interconnected slats such that the bottom slat substantially encloses the second connector and a portion of the adjacent slat, the bottom slat being substantially channel-shaped.
